(19) United States
(12) Patent Application Publication
(10) Pub. No.: US 2024/0418325 A1
(43) Pub. Date: Dec. 19, 2024

(54) Apparatus And Method For A Gas Storage System

(71) Applicant: Prometheus Energy Group, LLC, St. Charles, IL (US)

(72) Inventor: Nicolas Kernene, St. Charles, IL (US)

(21) Appl. No.: 18/817,020

(22) Filed: Aug. 27, 2024

Related U.S. Application Data
(63) Continuation of application No. PCT/US2023/063859, filed on Mar. 7, 2023.
(60) Provisional application No. 63/317,413, filed on Mar. 7, 2022.

(51) Int. Cl. F17C 11/00; H01M 8/04082

(52) U.S. Cl. CPC F17C 11/005; H01M 8/04216; F17C 2201/0119; F17C 2201/0166; F17C 2205/0111; F17C 2205/0138; F17C 2221/012; F17C 2270/0168; F17C 2270/0184

(57) ABSTRACT

A hydrogen gas storage unit includes at least two hydrogen gas storage chambers. The hydrogen gas storage unit comprises a cylindrical container having an end anvil at each end of the cylindrical container. The at least two hydrogen gas storage chambers are separated by an intermediate anvil and at least one spacer disk. The intermediate anvil has a channel that permits hydrogen gas to flow between the two hydrogen gas storage chambers. The spacer disk extends radially outward from the intermediate anvil and secures a diaphragm in position within at least one of the hydrogen gas storage chambers. A metal alloy that can store hydrogen gas is located between the outer surface of the diaphragm and the inner surface of the cylindrical container.

### RELATED APPLICATIONS

The present application is a continuation application of and claims priority to PCT Patent Application No. PCT/US2023/063859 filed Mar. 7, 2023, which claims the benefit of U.S. Provisional Patent Application No. 63/317,413 filed Mar. 7, 2022. The entire content of the foregoing applications is incorporated herein by reference.

### TECHNICAL FIELD

Embodiments of the technology relate generally to a gas storage system comprising multiple gas storage chambers wherein each chamber comprises a metal alloy material.

### BACKGROUND

Hydrogen is the object of significant research as an alternate fuel source to fossil fuels. Hydrogen is attractive because (i) it can be produced from many diverse energy sources, (ii) it has a high energy content by weight (about three times more than gasoline) and (iii) it has a zero-carbon emission footprint—the by-products of hydrogen combustion being oxygen and water.

However, hydrogen has physical characteristics that make it difficult to store in large quantities without taking up a significant amount of space. Despite hydrogen's high energy content by weight, hydrogen has a low energy content by volume. This makes hydrogen difficult to store, particularly within the size and weight constraints of a vehicle, for example. Another major obstacle is hydrogen's flammability and the concomitant safe storage thereof.

Known hydrogen storage technologies directed to high pressure tanks with compressed hydrogen gas and/or cryogenic liquid hydrogen storage have shortcomings because the risk of explosion still exists. These approaches require pressurized containers that are heavy and also require high energy input-features that detract from commercial viability.

Metal alloy hydrogen storage is based on materials capable of reversibly absorbing and releasing the hydrogen. Metal alloy hydrogen storage provides high energy content by volume, reduces the risk of explosion, and eliminates the need for high pressure tanks and insulation devices. Metal alloy hydrogen storage, however, struggles with low energy content by weight.

Examples of hydrogen storage devices using metal alloys are described in U.S. Pat. No. 9,841,147 to Kernene. However, additional advancements for improving the quantity and efficiency with which hydrogen is stored in a metal alloy storage device would be beneficial. In particular, storage devices that improve the energy density and facilitate use of the stored hydrogen in a variety of applications would be useful. Additionally, modular systems for storing hydrogen gas so that the modular systems can be deployed in vehicles, in portable generators, and energy storage systems would be desirable. Accordingly, examples of improved hydrogen storage systems and implementations are described herein. While the examples described herein primarily relate to the storage of hydrogen, it should be understood that the storage systems disclosed herein can be used to store other gases as well.

### SUMMARY

The present disclosure is generally directed to an improved gas storage unit for storing hydrogen as well as other gases. In one example embodiment, the gas storage unit can comprise a cylindrical container with first and second end anvils enclosing the cylindrical container. An intermediate anvil can be disposed within the cylindrical container between the first and second end anvils. A first gas storage chamber can be disposed within the cylindrical container and between the first end anvil and the intermediate anvil. The first gas storage chamber can comprise a first cylindrical diaphragm and a first metal alloy material disposed in a first annulus between the first cylindrical diaphragm and an inner surface of the cylindrical container. Similarly, the second gas storage chamber can comprise a second cylindrical diaphragm and a second metal alloy material disposed in a second annulus between the second cylindrical diaphragm and an inner surface of the cylindrical container.

The foregoing example embodiment of a gas storage unit can comprise one or more of the following example features. In one example, hydrogen gas can be stored in the first metal alloy material of the first gas storage chamber and in the second metal alloy material of the second gas storage chamber. The first gas storage chamber can be in fluid communication with the second gas storage chamber via a first anvil channel passing through the intermediate anvil. The gas storage unit can further comprise a spacer disk disposed between the first gas storage chamber and the second gas storage chamber. The first diaphragm can comprise a flange disposed between a raised inner flange of the spacer disk and the intermediate anvil

In the foregoing example embodiment, the intermediate anvil can be disposed between the spacer disk and a second spacer disk. The intermediate anvil can comprise an equatorial portion disposed between a raised flange of the spacer disk and a raised flange of the second spacer disk. The intermediate anvil can comprise a first side disposed within the first gas storage chamber and a second side disposed within the second gas storage chamber, wherein the first side and the second side of the intermediate anvil each have a truncated conical shape. The equatorial portion of the intermediate anvil can comprise radial channels extending from the intermediate anvil channel to a perimeter of the equatorial portion. Hydrogen gas can pass through the radial channels for storage in and release from the first metal alloy and the second metal alloy.

In the foregoing example embodiment, hydrogen gas can pass through the first cylindrical diaphragm for storage in and release from the first metal alloy and passes through the second cylindrical diaphragm for storage in and release from the second metal alloy.

In the foregoing example embodiment, the inner surface of the cylindrical container can comprise flutes and the spacer disk can comprise a perimeter having protrusions, wherein the protrusions of the spacer disk fit within the flutes of the inner surface of the cylindrical container.

In the foregoing example embodiment, the gas storage unit can be coupled to at least one other gas storage unit along a longitudinal axis of the gas storage unit.

In another example embodiment, the present disclosure is directed to a hydrogen storage assembly comprising a first hydrogen storage unit in fluid communication with a second hydrogen storage unit. The first hydrogen storage unit and the second hydrogen storage unit can each comprise the features of the gas storage unit described in the preceding paragraphs.

In the foregoing example of a hydrogen storage assembly, the hydrogen storage assembly can have a capacity of 6-42 kg of hydrogen and 203-1415 kWh of power. In another example, the hydrogen storage assembly can have a capacity of 3,000-4,500 kg of hydrogen and 100-200 MWh of power. In the foregoing example, the hydrogen storage assembly can be disposed in a shipping container. In the foregoing example, the first hydrogen storage unit and the second hydrogen storage unit can be coupled in series.

In yet another example embodiment, the present disclosure is directed to a hydrogen-powered generator comprising: a fuel cell; a power converter; and a hydrogen storage assembly comprising a first hydrogen storage unit in fluid communication with a second hydrogen storage unit. The first hydrogen storage unit and the second hydrogen storage unit can each comprise the features of the previously described gas storage unit.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments of gas storage systems and therefore are not to be considered limiting of the scope of this disclosure. The principles illustrated in the example embodiments of the drawings can be applied to alternate methods and apparatus for a gas storage system. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1 is a perspective view of a hydrogen storage unit in accordance with the example embodiments of the disclosure.

FIG. 2 is cross-sectional view of the hydrogen storage unit of FIG. 1 in accordance with the example embodiments of the disclosure.

FIG. 3 is a perspective view of the cylindrical container of FIG. 1 in accordance with the example embodiments of the disclosure.

FIG. 4 is an enlarged cross-sectional view of a portion of the hydrogen storage unit of FIG. 1 in accordance with the example embodiments of the disclosure.

FIG. 5 is an enlarged cross-sectional view of a portion of the hydrogen storage unit of FIG. 1 in accordance with the example embodiments of the disclosure.

FIG. 6 is a perspective view of a portion of the hydrogen storage unit of FIG. 1 in accordance with the example embodiments of the disclosure.

FIG. 7 is another perspective view of a portion of the hydrogen storage unit of FIG. 1 in accordance with the example embodiments of the disclosure.

FIG. 8 is a cross-sectional view of an assembly of hydrogen storage units in accordance with the example embodiments of the disclosure.

FIGS. 9A, 9B, 9C, 9D, and 9E illustrate additional configurations for assemblies of hydrogen storage units in accordance with the example embodiments of the disclosure.

FIGS. 10A and 10B illustrate larger scale assemblies of hydrogen storage units in accordance with the example embodiments of the disclosure.

FIG. 11 illustrates a generator containing one or more hydrogen storage units in accordance with the example embodiments of the disclosure.

### DETAILED DESCRIPTION OF EXAMPLE EMBODIMENTS

The example embodiments discussed herein are directed to a gas storage unit for storing hydrogen as well as other gases with improved efficiency and adaptability. The example embodiments described herein optimize the storage of hydrogen gas in a plurality of storage chambers within a gas storage unit. The hydrogen is adsorbed and/or absorbed by the metal alloys producing a metal hydride that can be stored in the storage units described herein. The metal hydride stored within the gas storage units is very stable allowing it to be easily transported and stored for several years with very little hydrogen loss. The hydrogen storage unit also is optimized to maximize the quantity of hydrogen stored within the volume of the unit. The hydrogen storage unit can be easily combined with multiple hydrogen storage units into an assembly. The configuration of the hydrogen storage unit facilitates the use of hydrogen as a fuel source, for example, in a vehicle, in a generator as a primary or backup power supply, or as a power source that can be used in remote locations lacking an electrical grid. As will be described further in the following examples, the methods and apparatus described herein improve upon prior approaches to storing hydrogen.

While the example embodiments described herein are directed to storage units for hydrogen gas, it should be understood that the storage units described herein can also be used to store other types of gases. Examples of gasses that can be stored in the storage units described herein include hydrogen, methane, ethane, propane, butane, hythane (hydrogen/methane), and combinations thereof.

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

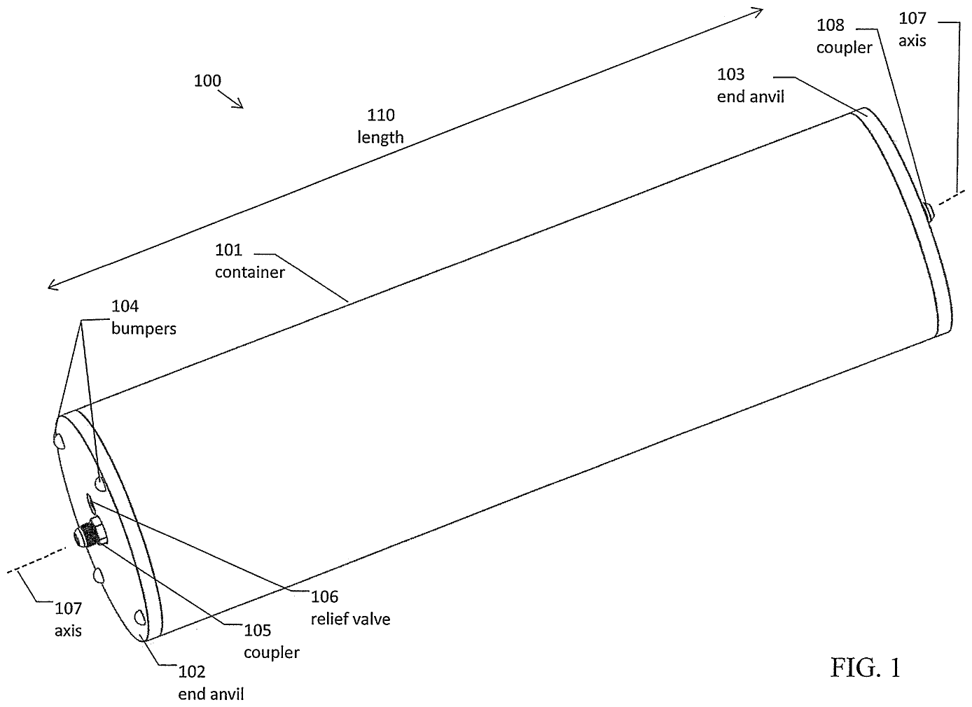

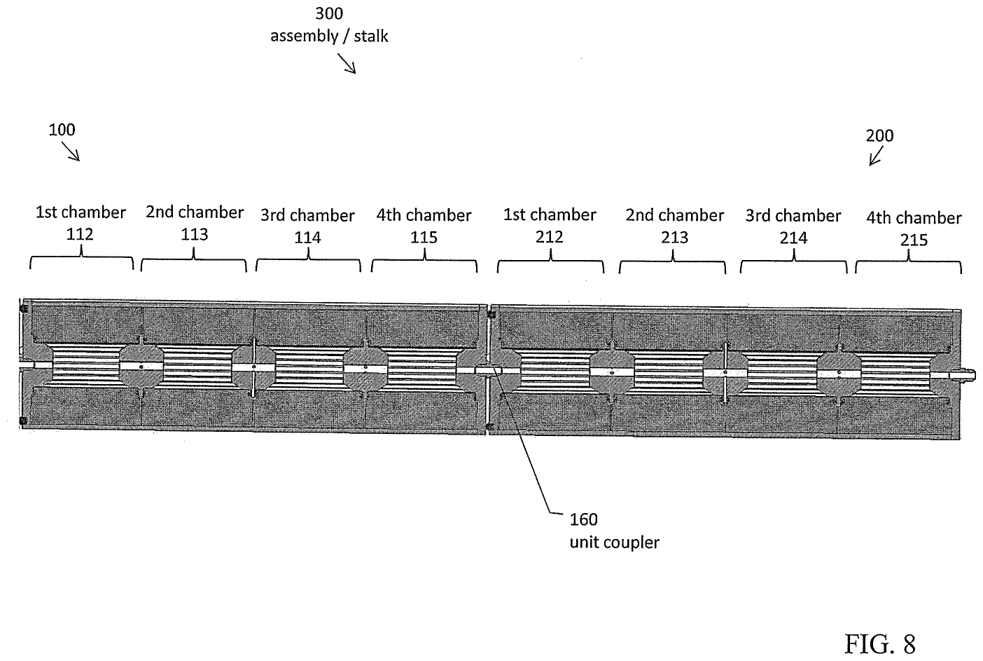

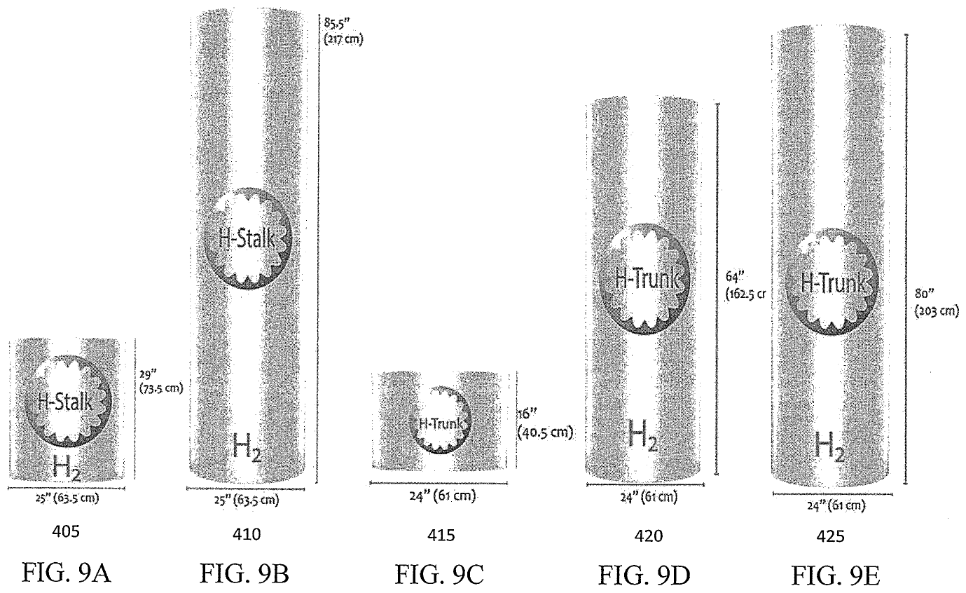

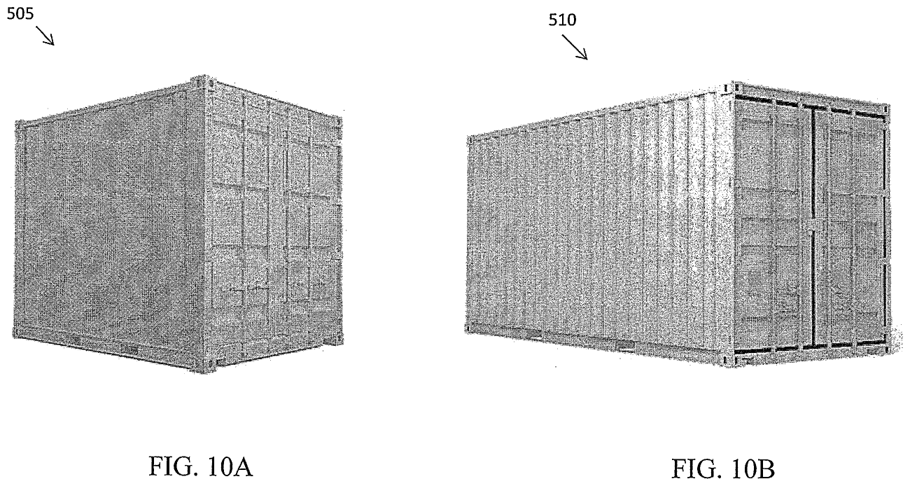

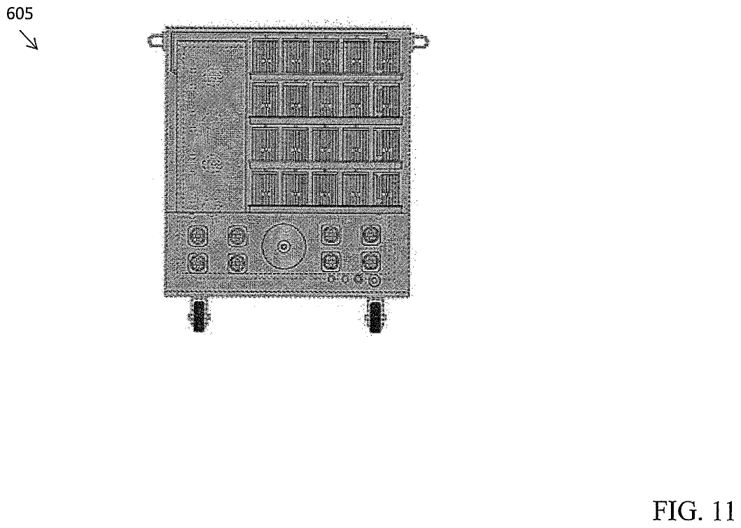

FIGS. 1-7 illustrate aspects of an example hydrogen gas storage unit 100 comprising multiple hydrogen gas storage chambers. FIG. 8 illustrates an example of an assembly of hydrogen gas storage units. FIGS. 9A-9E illustrate examples of additional configurations for assemblies of hydrogen storage units. FIGS. 10A and 10B illustrate examples of larger scale assemblies of hydrogen storage units. Lastly, FIG. 11 illustrates an example of a generator containing one or more hydrogen storage units.

Referring now to FIG. 1, a perspective view of the outside of an example gas storage unit 100 is illustrated. Gas storage unit 100 has a length 110 and is generally rotationally symmetrical about a central longitudinal axis 107. Gas storage unit 100 comprises an interior cylindrical cavity formed by cylindrical container 101, a first end anvil 102, and a second end anvil 103. When attached to the cylindrical container 101, the first end anvil 102 and second end anvil 103 form an enclosure for storing hydrogen or other gases. The first end anvil 102 and second end anvil 103 comprise couplers 105 and 108, respectively, that can connect the gas storage unit 100 to another gas storage unit, a fuel cell, a pump, a hydrogen source, or other appropriate equipment. The couplers can include a valve for controlling the flow of hydrogen into and out of the gas storage unit 100. As an example, when charging the gas storage unit 100 with hydrogen, the hydrogen can be pumped into one or both of the couplers 105, 108 at pressures ranging from 55 kPa (8 psi) to 2758 kPa (400 psi). One or both of the end anvils can be removably coupled to the cylindrical container 101 using fasteners such as bolts, screws, clips, detents, or other types of fastening devices. Additionally, the end anvils 102, 103 also can include bumpers 104 that protect the gas storage unit 100 from impacts. Although the container 101 is cylindrical with a generally circular shape when a cross-section is taken perpendicular to the central longitudinal axis 107 in the example of FIG. 1, it should be understood that in alternate embodiments the container can take other shapes such that the cross-section is elliptical or polygonal.

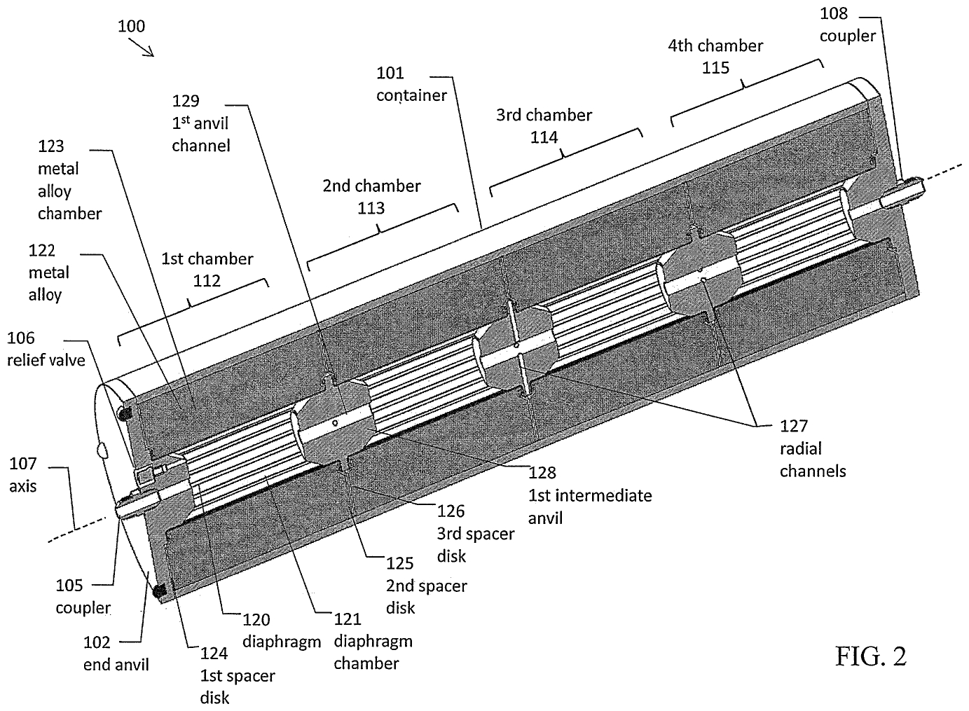

Referring now to FIG. 2, the gas storage unit 100 is shown in cross-section along the central longitudinal axis 107. As can be seen in FIG. 2, the gas storage unit 100 comprises four gas storage chambers-a first chamber 112, a second chamber 113, a third chamber 114, and a fourth chamber 115. In other embodiments, the gas storage units can comprise a fewer or greater number of gas storage chambers. The gas storage chambers are separated by intermediate anvils and spacer disks. Each gas storage chamber comprises a diaphragm that will be described in greater detail below. The following description provides details regarding the first chamber 112. It should be understood that the second, third, and fourth chambers are similar to the first chamber and, therefore, the descriptions of the first chamber can also apply to the features of the second, third, and fourth chambers.

Referring to FIG. 2, the first chamber 112 is defined by end anvil 102, first intermediate anvil 128, and the inner surface of the cylindrical container 101. A first spacer disk 124 is adjacent to the end anvil 102 and a second spacer disk 125 is adjacent the first intermediate anvil 128. A diaphragm 120 extends from the end anvil 102 and first spacer disk 124 at one end of the first chamber 112 to the first intermediate anvil 128 and second spacer disk 125 at the other end of the first chamber 112. In the example illustrated in the figures, the diaphragm has a generally cylindrical shape having a longitudinal axis that is co-axial with the axis 107 of the cylindrical container 101. An interior portion of the chamber, referred to as the diaphragm chamber 121, is defined by an inner surface of the diaphragm and the anvils located at opposing ends of the diaphragm. An outer portion of the chamber, referred to as the metal alloy chamber 123, is in the shape of an annulus and is defined by an outer surface of the diaphragm, an inner surface of the cylindrical container and the spacer disks located at opposing ends of the diaphragm. The metal alloy material 122 is positioned in the metal alloy chamber 123 between the outer surface of the diaphragm and the inner surface of the cylindrical container 101. In this way, the diaphragm and spacer disks hold the metal alloy in place in each gas storage chamber.

The metal alloy 122 is of a type that can absorb hydrogen gas to form a metallic hydride. The metal alloy can comprise any combination of the following materials: nickel, tin, aluminum, manganese, iron, cobalt, copper, titanium, antimony, and rare earth metals such as yttrium, lanthanum, cerium, prascodymium, and neodymium. The metal alloy is typically a granular material that forms a porous composition and may include a binding agent. The metal alloy granules can have a D50 particle size from 1.0 microns, or 1.5 microns, or 2.0 microns to 2.5 microns, or 3.0 microns, or 4.0 microns, or 5.0 microns. In one example, the D50 particle size of the metal alloy granules ranges from 1.5 microns to 2.0 microns. The term “D50” refers to the median diameter of the metal alloy granules such that 50% of the sample weight is above the stated particle diameter.

With each charging and discharging of the gas storage unit, hydrogen can flow between the coupler 105 and the metal alloy 122. Taking the charging of the gas storage unit 100 as an example, the hydrogen gas can enter the cylindrical container 101 through coupler 105 and through an end anvil channel in the end anvil 102, pass into the diaphragm chamber 121, and pass through the anvil channel of each intermediate anvil to flow into the next diaphragm chamber of the second, third, and fourth chambers. The flow of hydrogen between the diaphragm chambers and the metal alloy can take one or more paths depending upon the particular embodiment of the gas storage unit 100.

In one example embodiment, each diaphragm comprises a semi-permeable material that retains the metal alloy in the metal alloy chamber while permitting gaseous hydrogen to pass through the diaphragm and back and forth between the diaphragm chamber and the metal alloy chamber during charging and discharging of the gas storage unit 100. The hydrogen gas passes from the inner portion of the chamber through the semi-permeable membrane of each diaphragm and is stored in the metal alloy material in the outer portion of each chamber. Examples of the semi-permeable material of the diaphragm include, but are not limited to, polymeric materials such as polyethylene and polypropylene, as well as composite materials.

In another example embodiment, the hydrogen gas can pass between the diaphragm chambers and the metal alloy chambers via one or more radial channels 127 located in the intermediate anvils. As illustrated in FIG. 2, each intermediate anvil includes an anvil channel, such as anvil channel 129, that extends along the longitudinal axis 107 of the gas storage unit. Additionally, each intermediate anvil can include one or more radial channels 127 that provide a passage for the hydrogen gas to flow between the anvil channel and the metal alloy chamber. Although not visible in FIG. 2, a filter within or adjacent to the radial channels can permit the flow of hydrogen gas while preventing the metal alloy materials from escaping through the radial channels.

In yet another example embodiment, the intermediate anvils and spacer disks can include one or more ports permitting the flow of hydrogen between the diaphragm chamber and the metal alloy chamber. Moreover, other example embodiments can include combinations of the foregoing examples, such as an embodiment that includes both a hydrogen permeable membrane and radial channels in the intermediate anvils so that there is more than one path for the hydrogen to flow within each chamber.

When absorbed by the metal alloy material, the hydrogen gas can be stored in a stable and secure manner. When discharging hydrogen from the gas storage unit 100, the hydrogen gas flows from the metal alloy material in each chamber, through one of the previously described paths and into the diaphragm chamber from which it can exit through the channels passing through each anvil.

Referring to the first gas storage chamber 112, the diaphragm 120 is held in place between the end anvil 102 and the first intermediate anvil 128. The first disk spacer 124 is placed on the inner surface of the end anvil 102 and further secures one end of the diaphragm 120. At the opposite end of the first gas storage chamber 112, a second disk spacer 125 is co-axial with and surrounds the first intermediate anvil 128, securing the opposite end of the diaphragm 120. Each of the second chamber 113, the third chamber 114, and fourth chamber 115 has a similar arrangement to the first gas storage chamber 112.

Examples of suitable materials for the cylindrical container 101, the end anvils 102, 103, the intermediate anvils 128, and the spacer disks 124, 125, 126 include metals, polymeric materials, nanomaterials, and combinations thereof. Examples of suitable metals include aluminum, aluminum alloys, copper, steel, and combinations thereof. Examples of suitable polymeric material for the cylinder include carbon fiber, polyolefin, polycarbonate, acrylate, fiberglass, Ultem, and combinations thereof. The cylindrical container and its components may be a combination of metal and polymeric material such as a metal liner thermoset in a polymeric resin, for example.

In an embodiment, the cylindrical container 101 is composed of a heat conductive material. The metal alloy is packed against the inner surface of the cylindrical container 101 to facilitate the exchange of heat. The heat conductive material promotes heat dissipation (cooling) during charging of the gas storage unit with hydrogen and promotes warming during discharging of hydrogen from the gas storage unit. In this way, the cylindrical container functions as a heat exchanger and the gas storage unit eliminates the need for a separate heat exchanger and/or a separate coolant system. The structure and composition of the gas storage unit advantageously promotes energy efficiency, case-of-use, case-of-production, and reduction in weight.

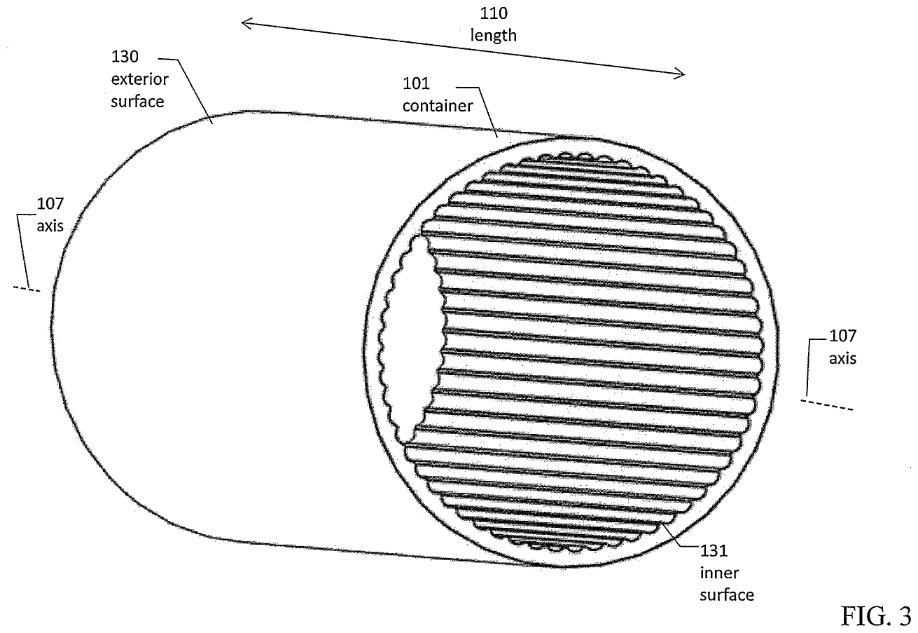

Referring now to FIGS. 3-7, additional details of the gas storage unit 100 will be described. As illustrated in FIGS. 3, 5, and 6, the disk spacers are configured to fit into fluting along the inner surface 131 of the cylindrical container 101. In the example of gas storage unit 100, the fluting runs continuously along the length 110 of the inner surface 131 of the cylindrical container 101. The fluting increases the surface area of the inner surface of the cylindrical container 101 thereby enhancing the exchange of heat through the cylindrical container 101 during charging and discharging of the gas storage unit. Extending the fluting along the entire length of the inner surface of the cylindrical container optimizes the increased surface area. The trough and peak of each flute of the fluting can be curved or pointed and can have a variety of dimensions. In a particular gas storage unit, the dimensions of each flute will typically be consistent about the inner circumference of the container 101. For example, in the case of curved flutes, each flute can have a radius of curvature in the range from 0.1 mm to 200 mm.

An additional advantage of extending the fluting along the entire length of the inner surface is that it provides flexibility in that the cylindrical container can be partitioned into a varying number of chambers as needed for a particular application. For instance, while the example gas storage unit 100 of FIGS. 1-8 is partitioned into 4 chambers, the fluting along the length of the inner surface allows for reconfiguring the gas storage unit so that there are a greater or fewer number of chambers of different length.

Yet another advantage of the fluting along the inner surface 131 of the cylindrical container 101 is that it forms a semicylindrical shape in the outer surface of the metal alloy where the metal alloy contacts the inner surface 131. The semi-cylindrical shape of the outer surface of the metal alloy fosters a helical flow path for the hydrogen as it moves through the metal alloy in a direction parallel to the longitudinal axis 107. A helical flow path can be beneficial because it can encourage more absorption of the hydrogen as it spends more time circulating through the metal alloy.

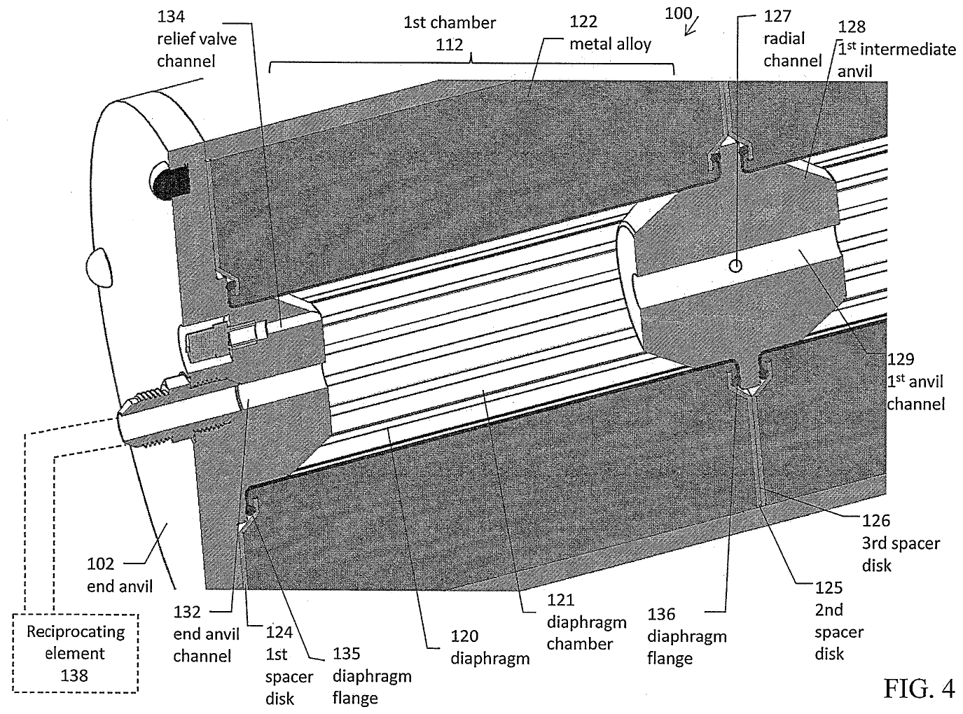

Lastly, yet another advantage of the fluting extending along the length of the inner surface is that it maintains symmetry about the central longitudinal axis 107. Maintaining a symmetrical interior volume of the gas storage unit can enhance the hydrogen storage capacity of the unit when a reciprocating element operating at a resonant frequency is used to pump hydrogen into the gas storage unit 100. The reciprocating element can be a solenoid, a vibration motor, a linear actuator, a piezoelectric drive, or a similar component. The reciprocating element can be located within the gas storage unit 100, for example as a component of an end anvil, or can be located external to the gas storage unit 100 and coupled to the coupler 105 or 108. An optional external reciprocating element 138 is illustrated as an example in FIG. 4. When the reciprocating element vibrates at a resonant frequency of the metal alloy 122 while hydrogen is being pumped into the gas storage unit 100, the reciprocating element can impart a vibrating or percussive force on the hydrogen and the metal alloy causing an expansion of the interstitial spaces in the metal alloy lattice structure and causing the metal alloy to achieve a super-saturated state storing additional hydrogen.

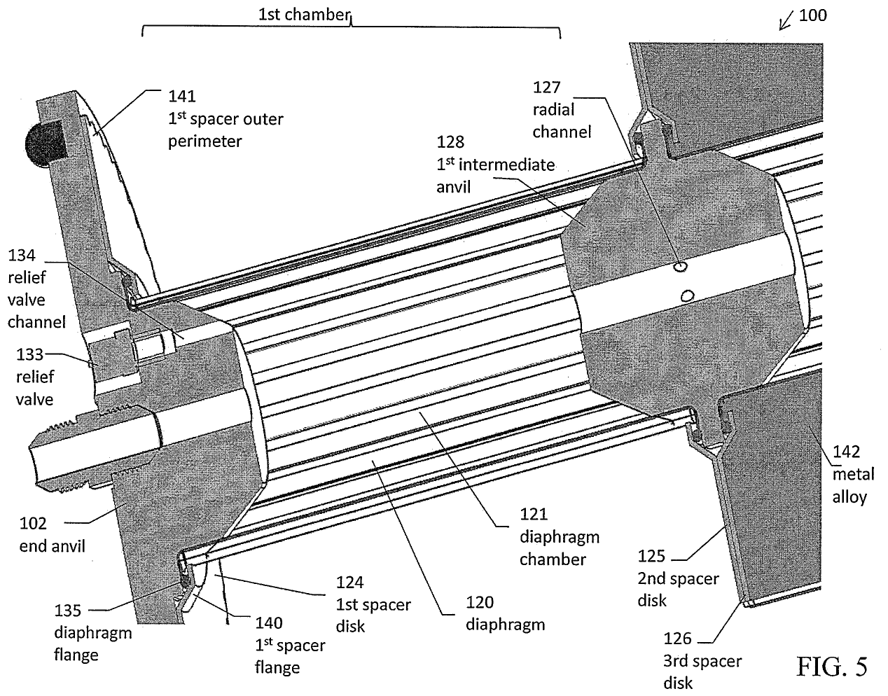

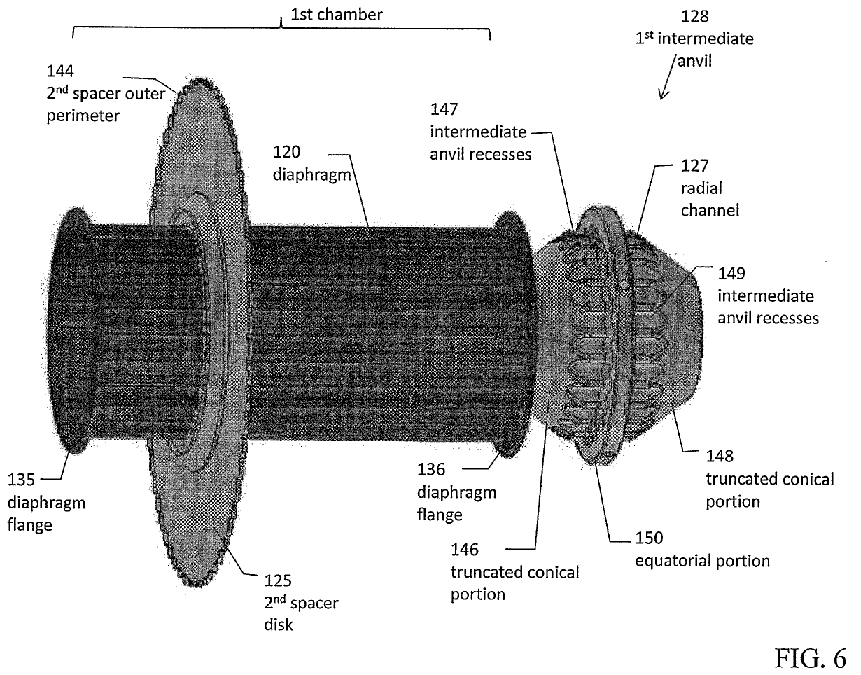

As illustrated in FIGS. 5 and 6, the spacer disks have protrusions along their outer perimeter that engage the fluting along the inner surface 131 of the cylindrical container 101. For example, first spacer disk 124 has an outer perimeter 141 with protrusions that fit into the flutes of the fluted inner surface 131 of the cylindrical container 101. Similarly, second spacer disk 125 has an outer perimeter 144 with protrusions that fit into the flutes of the fluted inner surface 131 of the cylindrical container 101. Engaging with the fluted inner surface assists in maintaining the spacer disks in their positions and assists with holding the metal alloy in place in the metal alloy chamber of each chamber 112, 113, 114, and 115 within the gas storage unit 100.

As illustrated in FIGS. 4, 5, and 6, the diaphragm 120 has a ribbed cylindrical shape with flanges at each end. FIG. 4 shows diaphragm flange 135 adjacent to the end anvil 102 and diaphragm flange 136 adjacent to first intermediate anvil 128. As further illustrated in FIGS. 4 and 5, each diaphragm flange is held in place by a spacer disk. Specifically, each spacer disk comprises the previously described outer perimeter as well as an inner perimeter defining a central aperture of the spacer disk. The spacer disk further comprises a spacer flange that is a raised portion along the inner perimeter of the spacer disk and the spacer flange retains the diaphragm flange against the adjacent anvil. For example, FIG. 5 shows first spacer flange 140 along the inner perimeter of first spacer disk 124 wherein the first spacer flange 140 retains the diaphragm flange 135 against end anvil 102. Similarly, second spacer disk 125 has a spacer flange along its inner perimeter which retains the diaphragm flange 136 against the first intermediate anvil 128.

The spacer disks provide other benefits as well. The spacer disks retain each of the intermediate anvils in the appropriate position and facilitate assembly of the gas storage unit. The spacer disks can be placed at various positions along the length of the gas storage unit to determine the length and the number of chambers within the gas storage unit. FIGS. 4, 5, and 6 illustrate further details as to the spacer disks retaining the intermediate anvils in desired positions. The intermediate anvils comprise truncated conical portions on opposing sides of the intermediate anvil and an equatorial portion between the truncated conical portions. The equatorial portions extend radially outward from the intermediate anvils. For example, FIG. 6 shows first intermediate anvil 128 comprising an equatorial portion 150 positioned between a truncated conical portion 146 and truncated conical portion 148. As further illustrated in FIGS. 4 and 5, the spacer flanges along the inner perimeters of the second spacer disk 125 and third spacer disk 126 envelope the equatorial portion 150 of the first intermediate anvil 128. Additionally, the truncated conical portions 146 and 148 fit into the central apertures of the second spacer disk 125 and the third spacer disk 126, respectively. Accordingly, the second spacer disk 125 and third spacer disk 126 thereby hold the first intermediate anvil 128 in the appropriate position.

Also visible in FIGS. 4, 5, 6, and 7 are the radial channels 127 extending radially outward in the equatorial portion 150 of the first intermediate anvil 128. As can be seen in the figures, the radial channels 127 provide a passageway from the first anvil channel 129 to the outer perimeter of the equatorial portion 150. Hydrogen gas can pass from the first anvil channel 129 through the radial channel 127 and exit the opening of the radial channel at the perimeter of the equatorial portion 150 where the hydrogen gas can then flow between the spacer disks 125 and 126 and into the metal alloy. As non-limiting examples, after flowing from anvil channel and through the radial channel, the hydrogen gas can pass into the metal alloy through spaces at the ends of the spacer disks or through perforations in the spacer disks when charging the hydrogen storage unit. When discharging the hydrogen storage unit, the gas follows the same path in reverse to flow from the metal alloy, into the radial channels, into the diaphragm chambers, and then out through one or both end anvil channels. As illustrated in FIG. 2, the other intermediate anvils of the gas storage unit 100 include similar radial channels.

FIG. 5 also illustrates the relief valve 133 and the relief valve channel 134 in the end anvil 102. The relief valve 133 can be calibrated to release hydrogen from the interior of the gas storage unit if pressure within the unit exceeds a predetermined level. In other embodiments, the pressure relief valve and channel can be located at other positions on the gas storage unit 100.

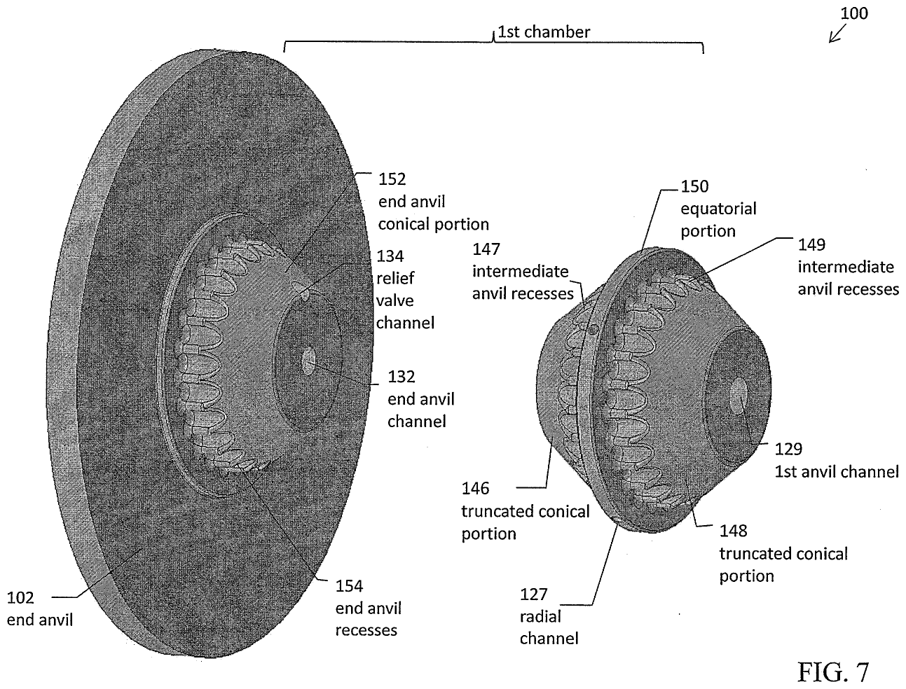

As illustrated in FIGS. 6 and 7, the anvils comprise recesses that received the fluted cylindrical shape of the diaphragm. The fluting of the diaphragm is optional, but provides certain advantages. First, the diaphragm is typically constructed of a flexible and resilient material that can flex permitting the volume of the metal alloy to expand as it absorbs hydrogen. Providing fluting in the flexible material of the diaphragm gives the diaphragm greater rigidity and strength. Second, the fluting of the diaphragm forms a semi-cylindrical pattern on the inner surface of the metal alloy similar to the effect of the fluted inner surface 131 of the cylindrical container 101 on the outer surface of the metal alloy. As described previously, this semi-cylindrical pattern of the metal alloy can promote a helical flow pattern as the hydrogen passes through the metal alloy in a direction generally parallel to the axis 107 of the hydrogen storage unit thereby encouraging greater absorption of hydrogen by the metal allow. In some example embodiments, the fluting of the diaphragm can have the same shape as and can align with the fluting along the inner surface 131 of the cylindrical container 101 so that the metal alloy has a shape generally similar to a collection of joined cylinders that surround the diaphragm.

The fluted shape of the diaphragm 120 is received in the end anvil recesses 154 and the intermediate anvil recesses 147. While the diaphragm's fluted shape is received in the recesses of each anvil, the diaphragm flange 135 is held between the end anvil 102 and the first spacer flange 140 and, at the opposite end of the chamber, the diaphragm flange 136 is held between the first intermediate anvil 128 and the spacer flange of the second spacer disk 125. Accordingly, the arrangement of the anvil recesses and the spacer disks holds the diaphragm in place and the diaphragm, in turn, holds the metal alloy in place in the metal alloy chamber of the gas storage chamber.

Also visible in FIGS. 6 and 7 are the truncated conical portions of the end anvil 102 and the first intermediate anvil 128. The end anvil 102 comprises an end anvil conical portion 152 that sits on a raised portion of the end anvil 102. The raised portion allows the first spacer disk 124 to sit securely against the end anvil 102 as illustrated in FIG. 5. The end anvil conical portion 152 has the shape of a truncated cone that fits through the central aperture of the first spacer disk 124. The end anvil recesses 154 are located along the base of the end anvil conical portion 152 and adjacent the raised portion of the end anvil 102. In FIG. 7, at the truncated end of the end anvil conical portion 152 the end anvil channel 132 and the relief valve channel 134 are visible. The first intermediate anvil 128 has a similar configuration, but includes two truncated conical portions 146 and 148 that are joined by the equatorial portion 150. Truncated conical portion 146 has intermediate anvil recesses 147 along its base and adjacent to the equatorial portion 150. On the opposite side of the equatorial portion 150, truncated conical portion 148 has intermediate anvil recesses 149 along its base and adjacent to the equatorial portion 150.

FIG. 8 illustrates an example configuration for multiple gas storage units. On the left is the example gas storage unit 100 described in connection with FIGS. 1-7. As described previously, the gas storage unit 100 comprises four chambers, 112, 113, 114, and 115. On the right is gas storage unit 200 which includes components and features, such as four chambers, 212, 213, 214, and 215, similar to unit 100. The combined units can be referred to as a gas storage assembly 300 or a stalk of gas storage units. The two gas storage units are joined by a unit coupler 160 that permits hydrogen to flow between the first unit 100 and the second unit 200. The unit coupler 160 can include a valve that controls the flow of hydrogen gas between the units. Hydrogen gas can enter and leave the gas storage assembly 300 through one or both ends of the gas storage assembly 300. Although only two gas storage units are illustrated in FIG. 8, it should be understood that additional gas storage units can be added to the assembly 300. Additionally, while assembly 300 includes two gas storage units joined in series, it should be understood that the gas storage units can be combined in parallel, or in both series and parallel, and joined by the appropriate unit couplers or manifolds.

The example gas storage assemblies illustrated in FIG. 8 and in the following figures have a variety of advantages. The gas storage assemblies have a storage density of at least 126.4 grams of hydrogen per liter. The input pressures required to charge the assemblies with hydrogen are in the range of 1 to 40 bar and, once charged, the assemblies store hydrogen and subsequently discharge the hydrogen at near atmospheric pressure. Given the stability of the gas storage units, their operation is quiet (under 55 dB) and their only emission is water allowing them to be used either indoors or outdoors as either a primary or backup power source. Furthermore, the gas storage assemblies have a lifecycle of approximately 20,000 respirations (cycles of charging and discharging hydrogen) and can safely store hydrogen for several years with very little loss of hydrogen.

FIGS. 9A, 9B, 9C, 9D, and 9E illustrate example configurations of gas storage assemblies comprising multiple gas storage units, such as the type previously described. The following are representative examples and it should be understood that other configurations of gas storage units are within the scope of this disclosure. Gas storage assembly 405 is a bundle of gas storage units in a cylindrical shell having dimensions of 25 inches wide by 29 inches tall that stores 14 kg of hydrogen which can supply 471 kWh. Gas storage assembly 410 is a bundle of gas storage units in a cylindrical shell having dimensions of 25 inches wide by 85.5 inches tall that stores 42 kg of hydrogen which can supply 1,415 kWh. Gas storage assembly 415 is suited for vehicles and is a bundle of gas storage units in a cylindrical shell having dimensions of 24 inches wide by 16 inches tall that stores 10.3 kg of hydrogen which can supply 346 kWh. Gas storage assembly 420 is suited for larger scale vehicles and is a bundle of gas storage units in a cylindrical shell having dimensions of 24 inches wide by 64 inches tall that stores 41.25 kg of hydrogen which can supply 1,386 kWh. Lastly, gas storage assembly 425 is suited for aviation and heavy equipment and is a bundle of gas storage units in a cylindrical shell having dimensions of 24 inches wide by 80 inches tall that stores 51.5 kg of hydrogen which can supply 1,730 kWh.

Referring to FIGS. 10A and 10B, examples of larger scale systems for the storage and transport of hydrogen are illustrated. The shipping containers 505 and 510 illustrated in FIGS. 10A and 10B can store many of the previously described gas storage assemblies to achieve volumes ranging from 3,000 kg to 5,000 kg of hydrogen. The shipping containers can include connections for respirating (charging and discharging) hydrogen from the gas storage units stored therein. Given the stability of the gas storage units, the shipping containers are self-contained and do not require external infrastructure such as temperature control or pressure control equipment. Additionally, the shipping containers can be stored aboveground or underground.

Referring now to FIG. 11, an example of a generator 605 is illustrated. The generator can comprise a plurality of the previously-described gas storage units as an energy source. The generator also includes a fuel cell for converting the hydrogen to electricity. A power converter, such as a boost converter and/or inverter, can be used to transform the electricity for a particular application. The generator 605 can include a programmable controller for controlling the operation of the generator. The controller can include a processor, memory, and a communication interface that allows a user to program aspects such as the charging and discharging times of the gas storage units within the generator as well as the characteristics (e.g., AC, DC, voltage level, current level) of the electricity the generator provides. In certain embodiments, the communication interface supports wireless communication allowing for remote monitoring and control of the generator.

For any apparatus shown and described herein, one or more of the components may be omitted, added, repeated, and/or substituted. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

Referring generally to the examples herein, any components of the apparatus (e.g., the container, the anvils, the spacer disks), described herein can be made from a single piece (e.g., as from a mold, injection mold, die cast, 3-D printing process, extrusion process, stamping process, or other prototype methods). In addition, or in the alternative, a component of the apparatus can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, and slotted fittings. One or more pieces that are mechanically coupled to each other can be coupled to each other in one or more of a number of ways, including but not limited to couplings that are fixed, hinged, removeable, slidable, and threaded.

Terms such as “first”, “second”, “top”, “bottom”, “side”, “distal”, “proximal”, and “within” are used merely to distinguish one component (or part of a component or state of a component) from another. Such terms are not meant to denote a preference or a particular orientation, and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Although example embodiments are described herein, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A gas storage unit comprising:
a cylindrical container;
a first end anvil at a first end of the cylindrical container;
a second end anvil at a second end of the cylindrical container;
an intermediate anvil disposed within the cylindrical container and between the first end anvil and the second end anvil;
a first gas storage chamber disposed within the cylindrical container and between the first end anvil and the intermediate anvil, wherein the first gas storage chamber comprises a first cylindrical diaphragm and a first metal alloy material disposed in a first annulus between the first cylindrical diaphragm and an inner surface of the cylindrical container; and
a second gas storage chamber disposed within the cylindrical container and between the intermediate anvil and the second end anvil, wherein the second gas storage chamber comprises a second cylindrical diaphragm and a second metal alloy material disposed in a second annulus between the second cylindrical diaphragm and the inner surface of the cylindrical container.

2. The gas storage unit of claim 1, wherein hydrogen gas is stored in the first metal alloy material of the first gas storage chamber and the second metal alloy material of the second gas storage chamber.

3. The gas storage unit of claim 1, wherein the first gas storage chamber is in fluid communication with the second gas storage chamber via a first anvil channel passing through the intermediate anvil.

4. The gas storage unit of claim 3, further comprising a spacer disk disposed between the first gas storage chamber and the second gas storage chamber.

5. The gas storage unit of claim 4, wherein the first diaphragm comprises a first diaphragm flange disposed between an inner flange of the spacer disk and the intermediate anvil.

6. The gas storage unit of claim 4, wherein the intermediate anvil is disposed between the spacer disk and a second spacer disk.

7. The gas storage unit of claim 6, wherein the intermediate anvil comprises an equatorial portion disposed between a flange of the spacer disk and a flange of the second spacer disk.

8. The gas storage unit of claim 7, wherein the intermediate anvil comprises a first side disposed within the first gas storage chamber and a second side disposed within the second gas storage chamber, wherein the first side and the second side of the intermediate anvil each have a truncated conical shape.

9. The gas storage unit of claim 7, wherein the equatorial portion of the intermediate anvil comprises radial channels extending from the intermediate anvil channel to a perimeter of the equatorial portion.

10. The gas storage unit of claim 9, wherein hydrogen gas passes through the radial channels for storage in and release from the first metal alloy and the second metal alloy.

11. The gas storage unit of claim 1, wherein hydrogen gas passes through the first cylindrical diaphragm for storage in and release from the first metal alloy and passes through the second cylindrical diaphragm for storage in and release from the second metal alloy.

12. The gas storage unit of claim 4,
wherein the inner surface of the cylindrical container comprises flutes;
wherein the spacer disk comprises a perimeter having protrusions; and
wherein the protrusions of the spacer disk fit within the flutes of the inner surface of the cylindrical container.

13. The gas storage unit of claim 1, wherein the gas storage unit is coupled to at least one other gas storage unit along a longitudinal axis of the gas storage unit.

14. A hydrogen storage assembly comprising a first hydrogen storage unit in fluid communication with a second hydrogen storage unit via a fluid connector, wherein the first hydrogen storage unit and the second hydrogen storage unit each comprise:
a cylindrical container;
a first end anvil at a first end of the cylindrical container;
a second end anvil at a second end of the cylindrical container;
an intermediate anvil disposed within the cylindrical container and between the first end anvil and the second end anvil;
a first hydrogen storage chamber disposed within the cylindrical container and between the first end anvil and the intermediate anvil, wherein the first hydrogen storage chamber comprises a first cylindrical diaphragm and a first metal alloy material disposed in a first annulus between the first cylindrical diaphragm and an inner surface of the cylindrical container; and
a second hydrogen storage chamber disposed within the cylindrical container and between the intermediate anvil and the second end anvil, wherein the second hydrogen storage chamber comprises a second cylindrical diaphragm and a second metal alloy material disposed in a second annulus between the second cylindrical diaphragm and the inner surface of the cylindrical container.

15. The hydrogen storage assembly of claim 14, wherein the hydrogen storage assembly has a capacity of 6-42 kg of hydrogen and 203-1415 kWh of power.

16. The hydrogen storage assembly of claim 14, wherein the hydrogen storage assembly is disposed in a shipping container.

17. The hydrogen storage assembly of claim 14, wherein the hydrogen storage assembly has a capacity of 3,000-4,500 kg of hydrogen and 100-200 MWh of power.

18. The hydrogen storage assembly of claim 14, wherein the first hydrogen storage unit and the second hydrogen storage unit are coupled in series.

19. A hydrogen-powered generator comprising:
a fuel cell;
a power converter; and
a hydrogen storage assembly comprising a first hydrogen storage unit in fluid communication with a second hydrogen storage unit via a fluid connector, wherein the first hydrogen storage unit and the second hydrogen storage unit each comprise:
a cylindrical container;
a first end anvil at a first end of the cylindrical container;
a second end anvil at a second end of the cylindrical container;
an intermediate anvil disposed within the cylindrical container and between the first end anvil and the second end anvil;
a first hydrogen storage chamber disposed within the cylindrical container and between the first end anvil and the intermediate anvil, wherein the first hydrogen storage chamber comprises a first cylindrical diaphragm and a first metal alloy material disposed in a first annulus between the first cylindrical diaphragm and an inner surface of the cylindrical container; and
a second hydrogen storage chamber disposed within the cylindrical container and between the intermediate anvil and the second end anvil, wherein the second hydrogen storage chamber comprises a second cylindrical diaphragm and a second metal alloy material disposed in a second annulus between the second cylindrical diaphragm and the inner surface of the cylindrical container.

20. The hydrogen-powered generator of claim 19, wherein the power converter is one of an inverter, a boost converter, and a switched mode power supply.
